(19) United States
(12) Patent Application Publication
(10) Pub. No.: US 2007/0119033 A1
(43) Pub. Date: May 31, 2007

(54) Automotive glass clamping system

(75) Inventors: Todd S. Gray, Regina (CA); Stephen Schoonbaert, Ottawa (CA)

Correspondence Address: JONES, TULLAR & COOPER, P.C., P.O. BOX 2266 EADS STATION, ARLINGTON, VA, 22202, US

(73) Assignees: Her Majesty The Queen In Right of Canada As Represented by the Honourable Stockwell Day,; Minister of Public Safety

(21) Appl. No.: 11/604,714

(22) Filed: Nov. 28, 2006

Related U.S. Application Data
(60) Provisional application No. 60/740,243, filed on Nov. 29, 2005.

(51) Int. Cl. F16B 2/02

(52) U.S. Cl. 24/478; 248/544

(57) ABSTRACT

A clamping system for securing a sheet of automotive glass exterior to a window opening in a vehicle door includes first and second clamping units adapted for, respectively, securely supporting therebetween the sheet of automotive glass. The first clamping unit is supporting from a frame of the vehicle door and the second clamping unit is supported on an outside panel of the door. Each of the clamping units includes inner and outer clamping bars adjustably holding the sheet of automotive glass therebetween, the first clamping unit being adapted to hold the sheet adjacent an upper edge thereof and the second clamping unit being adapted to hold the sheet adjacent a lower edge thereof. The system is used in training exercises for emergency measures personnel who need to be able to break automotive glass to gain entrance to a vehicle.

### CROSS-REFERENCE TO RELATED APPLICATION

This application claims the benefit of U.S. Provisional Patent Application Ser. No. 60/740,243 filed Nov. 29, 2005.

### FIELD OF THE INVENTION

The invention relates to a clamping system for securing a sheet of automotive glass over existing window opening in a vehicle door.

### BACKGROUND OF THE INVENTION

Emergency Response Teams (ERT) are trained in numerous rescue and/or take-down manoeuvres wherein the ERT officers are required to remove and/or stun the occupants of an automobile or vehicle. These manoeuvres often require breaking the automobile side windows in order to gain access-to the occupants. Therefore, during training exercises a vehicle can be used a maximum of four times (for standard four-door vehicles) to recreate the exercise. Once the windows have been destroyed, the officers participating in the training can no longer practice destroying the window as they approach the vehicle. At this point, the training becomes unrealistic and less effective since the officers are unable to complete the exercise. Therefore, once all the windows in the vehicle have been destroyed, the vehicle essentially becomes obsolete since it can no longer serve as an effective training unit. Accordingly, during the course of training, multiple vehicles are required in order to stage appropriate drills. Furthermore, once all of the existing windows have been destroyed, the vehicle can no longer be used for any other outdoor training exercises in poor weather conditions since the interior of the vehicle cannot be protected from the elements as there are no windows left to roll-up. Therefore, once the windows have been destroyed, the vehicle becomes unsuitable for training purposes rendering the training process costly wasteful and inefficient.

In view of the foregoing, it is desirable to develop a technology that enables ERT officers to be able to repeatedly practice vehicle take-downs that involve the breaking of vehicle windows, without destroying the original windows on the vehicle rendering the vehicle obsolete.

U.S. Pat. No. 5,820,119 to Chacon, Sr. discloses a window retaining apparatus used to hold the rear window of a truck in place in the window frame while the urethane seal therebetween is curing. The apparatus disclosed comprises a telescoping body portion made up of inner and outer tubular sections so that the unit can be adjusted to suit various sizes of windows. Suction cups are used to engage the glass window panel, while tie-down clamps, located at opposite ends of the unit are used to engage the window frame. In use, the apparatus allows for the glass window panel to be held in place and to be pressed against the window frame while the urethane seal therebetween cures. The apparatus is advantageous in that the glass window panel no longer needs to be held in place manually during the curing process.

While Chacon, Sr. discloses a type of clamping unit that is adjustable to suit different sized windows and employs suction cups and hook-type fasteners to secure the clamping unit to the automobile when in use, the unit is not suitable or easily adaptable for use as a training unit. The clamping unit disclosed by Chacon, Sr. holds the window panel in the actual opening of the doorframe; therefore the original window panel would have to be removed and the vehicle would not remain in a usable condition. Accordingly, the unit disclosed by Chacon Sr. does not meet the needs that are addressed by the present invention.

### SUMMARY OF THE INVENTION

The present invention provides a clamping system for securing a sheet of automotive glass over an existing window opening in a vehicle door. The system provides first and second clamping units adapted for securely supporting the sheet of automotive glass therebetween. First means associated with the first clamping unit supports the first clamping unit from a frame of a vehicle door and second means associated with the second clamping unit supports the second clamping unit on an outside panel of the door. Each clamping unit includes inner and outer clamping bars which adjustably hold the sheet of automotive glass therebetween, the first clamping unit being adapted to hold an upper portion of the sheet adjacent an upper edge thereof and the second clamping unit being adapted to hold a lower portion of the sheet adjacent a lower edge thereof. Once the sheet of automotive glass has been broken as part of a training exercise the broken remnants of the sheet are removed from the clamping units and replaced with a new sheet of glass so that training can continue.

### BRIEF DESCRIPTION OF THE DRAWINGS

The present invention will be better understood with reference to the detailed description taken in combination with the drawings in which:

FIG. 1 is a perspective view of a vehicle showing the clamping system of the present invention in use thereon;

FIG. 2 is a perspective view of the upper clamping unit of the clamping system according to a preferred embodiment;

FIG. 3 is a perspective view of the lower clamping unit of the clamping system according to a preferred embodiment.

FIG. 4 is a cross-sectional view illustrating the manner in which the upper clamping unit is suspended on a vehicle door frame; and

FIG. 5 is a view similar to FIG. 3 showing an alternate means for securing the suction cups to the lower clamping unit.

### DETAILED DESCRIPTION OF THE INVENTION

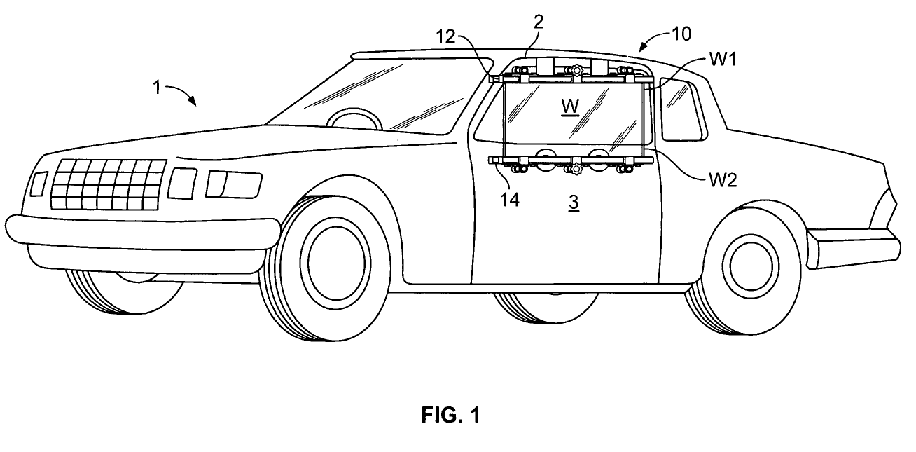

Referring to the drawings, there is shown in FIG. 1 the clamping system 10 according to a preferred embodiment of the invention in use on a vehicle 1. The clamping system 10 comprises an upper clamping unit 12 adapted to engage the upper portion of the doorframe 2 of the vehicle 1, and a lower clamping unit 14 adapted to be secured to the outer surface of the door 3 of the vehicle 1 below the lower portion of the window opening. The clamping system 10 serves to hold a sheet W of automotive window glass in place over where the original window is located in the vehicle door. Therefore, the glass sheet W can easily be replaced multiple times during training exercises without damaging the original vehicle windows.

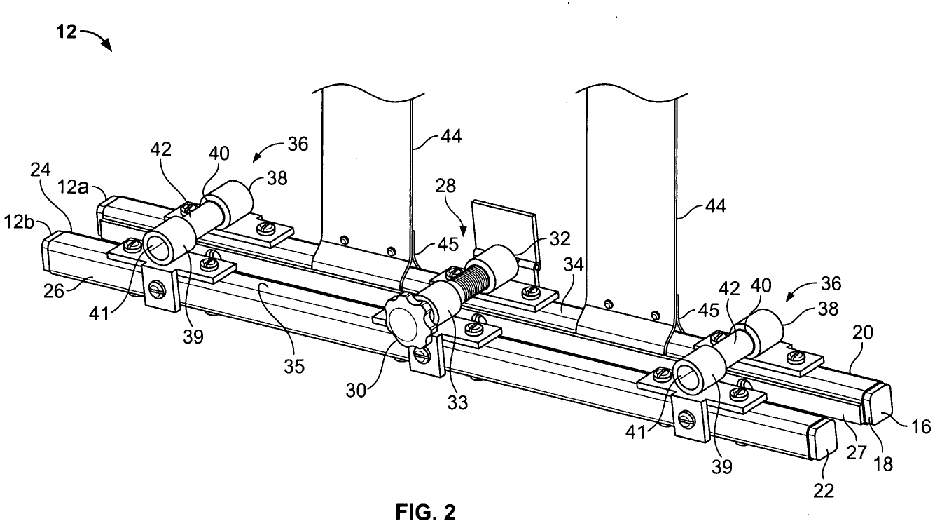

The upper or first clamping unit 12, as shown in FIG. 2, comprises first (inner) and second (outer) clamping bars 12a, 12b which cooperate in order to engage an upper portion W! of the sheet W of automotive window glass. The first clamping bar 12a comprises an elongated body 16 having an inner surface 18 and an outer surface 20 which is most proximal to the vehicle doorframe 2 when the clamping system 10 is in use. The second clamping bar 12b also comprises an elongated body 22 having an inner surface 24, which is opposite to the inner surface 18 of the first clamping bar 12a. The outer surface 26 of the second clamping bar 12b is located most distal to the vehicle doorframe 2 when the clamping system 10 is in use. Each of he inner surfaces 18, 24 of the first and second clamping bars 12a, 12b is preferably equipped with a strip of cushioning material 27 along the length of the respective elongated bodies 16, 22 so as to protect the glass window panel W when the upper clamping unit 12 is secured thereto. The cushioning material 27 prevents premature cracking of the glass window panel W from the hard surface of the bodies 16, 22 of the first and second clamping bars 12a, 12b.

The upper clamping unit 12 includes an adjustable locking means 28 for bringing the first and second clamping bars 12a, 12b into engagement with the upper portion W1 of the glass window panel W adjacent the upper edge thereof. Preferably, the locking means 28 comprises an elongated threaded member (or bolt) 30 which is inserted into corresponding annular receiving brackets or bosses 32, 33 each of which is mounted on the respective upper surface 34, 35 of the first and second clamping bars 12a, 12b. The receiving boss 32 located on the first clamping bar 12a is threaded internally for receiving and engaging with the threads on the elongated threaded member 30. The receiving boss 33 located on the second clamping bar 12b does not require internal threading as the elongated threaded member 30 is intended to rotate freely within the receiving boss 33. Once the elongated threaded member 30 engages with the threads on the inside surface of the receiving boss 32, rotation of the elongated threaded member 30 draws the first and second clamping bars 12a, 12b towards each other and eventually into contact with the glass window panel W.

In order to prevent the first and second clamping bars 12a, 12b from twisting with respect to each other as the threaded member 30 is screwed into the receiving boss 32, aligning means 36 are provided which serve to both align and stabilize the clamping bars 12a, 12b with respect to each other. The aligning means 36 are located on either side of the locking means 28 and are disposed towards the ends of the clamping bars 12a, 12b. The aligning means 36 preferably comprise corresponding first and second bracket elements or annular bosses 38, 39 positioned on the respective upper surfaces 34, 35 of the first and second clamping bars 12a, 12b. An aperture 40, 41 extends through each of the first and second bosses 38, 39, the aperture 40, 41 being sized to receive an aligning rod 42. The aligning rod 42 is inserted through the apertures 40, 41 in the first and second bosses 38, 39, thereby ensuring that the first and second clamping bars 12a, 12b remain in a substantially parallel relationship when in use. The aligning rod 42 can be formed from any suitable means such as a wooden dowel, or a metal or plastic rod.

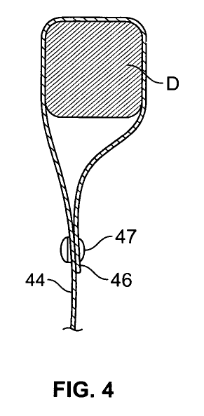

The upper clamping unit 12 is preferably affixed to the door frame by means of tether straps 44 positioned on either side of the centrally located locking means 28. The straps 44 are attached at a first end 45 to the first clamping bar 12a between the adjustable locking means and aligning means by means of screws that are hidden behind the strip of cushioning material 27. As shown in FIG. 4, the second end 46 of said straps wrap or loop around the upper portion of the doorframe D, and are secured in place by means of snaps 47 or any other suitable means thereby attaching the upper clamping unit 12 to the vehicle. The straps 44 can be made of nylon or any other suitable materials, and are of a standard width. The straps 44 also have sufficient length to allow for vertical adjustment by means of a plastic clip system (not shown), similar to the straps found on conventional backpacks. In use, the snaps 47 (or other locking means) at the second end 46 of the straps 44 are opened and the second end 46 is looped around the upper portion of the doorframe. The second end 46 is then snapped shut and the length of the straps 44 is adjusted using the plastic clips. The glass window panels that are used in conjunction with the clamping system 10 are not very heavy; therefore additional reinforcing means are not required. The maximum weight that has been used for the glass window panel has been about 5 lbs.

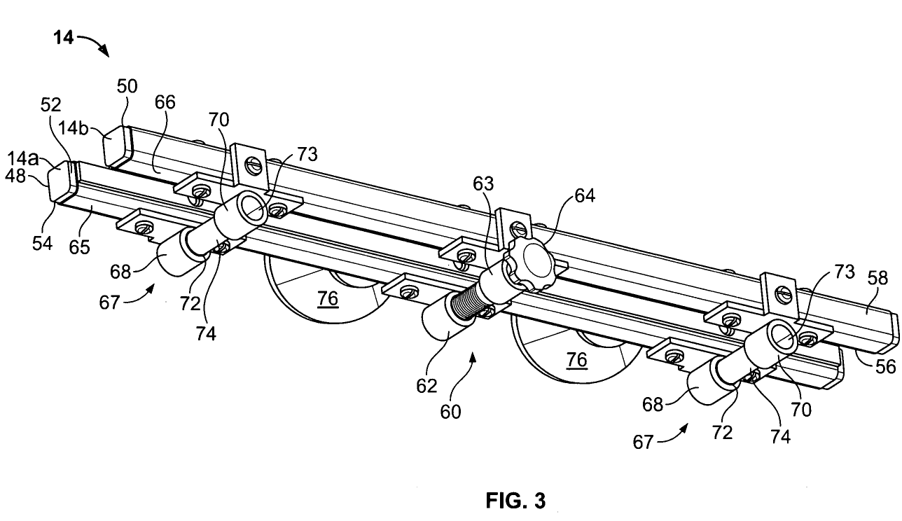

The lower clamping unit 14, shown in FIG. 3, is similar in structure to the upper clamping unit 12 in that it too comprises first (inner) and second (outer) clamping bars 14a, 14b. Each of the first and second clamping bars 14a, 14b comprises an elongated body 48, 50, and is adapted to cooperate in order to engage a lower portion W2 of the automobile glass window panel W adjacent a lower edge thereof. Similar to the upper clamping unit 12, the elongated body 48 of the first clamping bar 14a of the lower clamping unit 14 has an inner surface 52 adapted for receiving the lower portion W2 of the window panel W, and an outer surface 54 which is most proximal to the vehicle door 3 when the clamping system 10 is in use. The elongated body 50 of the second clamping bar 14b of the lower clamping unit 14 also has an inner surface 56, which corresponds to the inner surface 52 of the first clamping bar 14a for receiving the lower portion of the window panel. The outer surface 58 of the second clamping bar 14b is located most distal to the vehicle door 3 when the clamping system 10 is in use.

As with the upper clamping unit 12, the lower clamping unit 14 also includes adjustable locking means 60 comprising a pair of annular receiving brackets or bosses 62, 63, and an elongated threaded member 64 (or bolt). The receiving bosses 62, 63, however, are instead mounted on the bottom surface 65, 66 of each of the first and second clamping bars 14a, 14b. The receiving boss 62 that is mounted on the first clamping bar 14a is threaded internally for engaging with the threads on the elongated threaded member 64 as it is inserted into the receiving bosses 62, 63. Once the elongated threaded member 64 engages with the threads on the inside surface of the receiving boss 62, rotation of the elongated threaded member 64 draws the first and second clamping bars 14a, 14b towards each other and eventually into contact with the glass window panel W. The lower clamping unit 14 also include aligning means 67 identical to the aligning means 36 provided on the upper clamping unit 12. Accordingly, the aligning means 67 comprises corresponding first and second bracket elements or bosses 68, 70 positioned on the bottom surfaces 65, 66 of the clamping bars 14a, 14b. An aperture 72, 73 extends through each of the first and second bracket elements 68, 70, the apertures 72, 73 being sized to receive an aligning rod 74. The aligning rod 74 is inserted through the apertures 72, 73 in the first and second bracket elements 68, 70, thereby ensuring that the first and second clamping bars 14a, 14b remain in a substantially parallel relationship when the lower clamping unit 14 is in use.

The lower clamping unit 14 differs from the upper claming unit 12 in that it is preferably secured to the door of the vehicle by means of suction cups 76. The suction cups 76 are positioned on either side of the centrally located locking means 60 equidistant from locking means 60 and the aligning means 67. The suction cups 76 are attached to the outer surface 54 of the first clamping bar 14a with a hinge mechanism (not visible in FIG. 3) so that the suction cups 76 can be angled to ensure a proper seal with the surface of the vehicle door 3. The size of the automobile glass window panel W used will determine the exact position of the lower clamping unit 14 on the surface of the door; therefore the hinge mechanism is desirable in order to ensure that the suction cups 76 can be adjusted to accommodate variations in door panel structures.

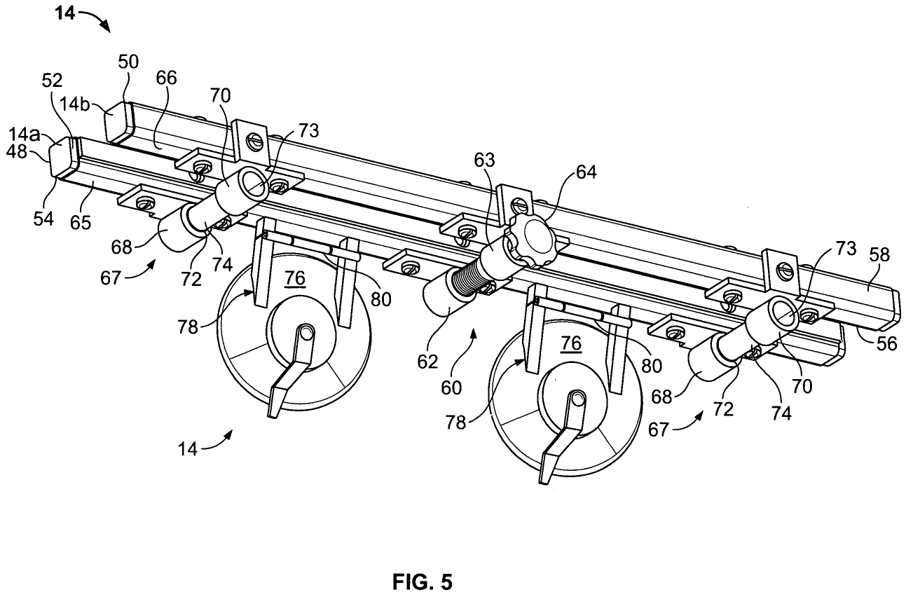

According to another embodiment of the invention, as seen in FIG. 5, the lower clamping unit 14 is designed so that the suction cups 76 are secured to the bottom surface 65 of the first clamping bar 14a. In this embodiment, the suction cups 76 each include a mounting bracket 78 that incorporates the hinge mechanism 80. A screw is used to secure the mounting bracket 78 to the bottom surface 65 of the first clamping bar 14a.

As mentioned above, the glass window panel W used with the clamping system 10 is not very heavy. Nevertheless, it is preferable to design the lower clamping unit 14 to be able to carry additional weight to ensure that the clamping system 10 is secure. Accordingly, the suction cups 76 used on the lower clamping unit 14 are adapted to be able to support a load of up to 25 lbs, even although the glass window panel does not usually exceed 5 lbs.

When the clamping system 10 is in use, the automobile glass window panel W is first secured in the upper and lower clamping units 12, 14. The clamped window panel is then lifted towards the vehicle door where the original window has been rolled downwards into its retracted position, exposing the vehicle interior via the window opening. With the door 3 of the vehicle in the open position, the straps 44 are then affixed to the upper portion D of the doorframe 2 thereby positioning the upper clamping unit 12 and the glass window panel W in place over the original window opening in the door. The lower clamping unit 14 is then secured to the outer surface of the vehicle door panel by applying pressure to the suction cups 76 which then adhere to the door panel surface. Once the clamping system 10 and the glass window panel W are in place over the original window opening in the vehicle door, the training exercise can begin and the glass window panel can be broken without damaging the original window. Once the training exercise is complete, a new automobile glass window panel can be inserted into the clamping system 10 and the training exercise can be repeated. Once training has been completed, the vehicle remains completely usable as the clamping system 10 can easily be removed from the vehicle 1 and the original windows can be raised or rolled-up into their closed position.

While the present invention has been described with respect to certain preferred embodiments, it will be understood by persons skilled in the art that variations or modifications can be made without departing from the scope of the invention as described herein.

1. A clamping system comprising:
first and second clamping units adapted for, respectively, securely supporting therebetween a sheet of automotive glass;
first means associated with said first clamping unit for supporting said first unit from a frame of a vehicle door; and
second means associated with said second clamping unit for supporting said second unit on an outside panel of said door;
each of said clamping units including inner and outer clamping bars adjustably holding said sheet of automotive glass therebetween, said first clamping unit being adapted to hold said sheet adjacent an upper edge thereof and said second clamping unit being adapted to hold said sheet adjacent a lower edge thereof.

2. The clamping system of claim 1 wherein each of said clamping bars is elongated, with a layer of compressible material located on a face thereof against which said sheet of automotive glass is positioned.

3. The clamping system of claim 2 wherein one of said inner and outer clamping bars of each clamping unit includes a threaded boss thereon and the other of said inner and outer clamping bars of each clamping unit includes an annular boss thereon, said system including a threaded bolt adapted for smooth passage through said annular boss and threaded reception in said threaded boss for adjustably securing said inner and outer clamping bars together with said sheet of automotive glass therebetween.

4. The clamping system of claim 3 wherein said threaded and annular bosses are generally centrally located on the respective clamping bars and outwardly thereof there is provided a pair of alignment bosses on each said clamping bar with an alignment rod extending between respective alignment bosses of said inner and outer clamping bars for aligning said clamping bars with respect to each other.

5. The clamping system of claim 4 wherein said first supporting means comprises a pair of tether straps spaced apart along the length of, and secured to, the inner clamping bar of said first clamping unit for attachment to an upper frame portion of said vehicle door frame.

6. The clamping system of claim 5 wherein each said tether strap includes first and second snap fastener elements spaced apart along the length thereof such that a free end of each strap can be wrapped around such upper frame portion of the vehicle door frame and said first and second snap fasteners can be connected together to secure such tether strap in position for supporting said clamping units and automotive glass on such vehicle door.

7. The clamping system of claim 6 including clip means for adjusting the length of each such tether strap to compensate for different sizes of vehicle doors.

8. The clamping system of claim 7 wherein said second supporting means comprises at least two suction cups hingedly connected to the inner clamping bar of said second clamping unit for securely supporting said second clamping unit against the outer panel of said vehicle door.

9. The clamping system of claim 8 including, for each suction cup, a hinged bracket affixed to an inner face of said inner clamping bar and to an adjacent surface of such suction cup.

10. The clamping system of claim 8 including, for each suction cup, a hinged bracket affixed to a lower face of said inner clamping bar and to an adjacent surface of such suction cup.

11. A clamping system for supporting a sheet of automotive glass adjacent a window opening in a vehicle door, such door including a frame extending around forward, upper, and rear portions of the window opening, and an outer panel below the window opening, said system comprising:
a first clamping unit including elongated inner and outer clamping bars for clamping therebetween an upper portion of such sheet of automotive glass;
a second clamping unit including elongated inner and outer clamping bars for clamping therebetween a lower portion of such sheet of automotive glass;
a pair of tether straps affixed to said inner clamping bar of said first clamping unit, each said tether strap being adapted for secure attachment to the upper portion of said door frame;
a pair of suction cups hingedly affixed to said inner clamping bar of said second clamping unit, each said suction cup being engageable with said panel of said vehicle door;
said tether straps and said suction cups serving to support said first and second clamping units and the sheet of automotive glass held thereby on said vehicle door in a position covering said window opening thereof.

12. The clamping system of claim 11 wherein each of said elongated clamping bars has a layer of compressible material located on a face thereof against which said sheet of automotive glass is positioned.

13. The clamping system of claim 12 wherein one of said inner and outer clamping bars of each clamping unit includes a threaded boss thereon and the other of said inner and outer clamping bars of each clamping unit includes an annular boss thereon, said system including a threaded bolt adapted for smooth passage through said annular boss and threaded reception in said threaded boss for adjustably securing said inner and outer clamping bars together with said sheet of automotive glass therebetween.

14. The clamping system of claim 13 wherein said threaded and annular bosses are generally centrally located on the respective clamping bars and outwardly thereof there is provided a pair of alignment bosses on each said clamping bar with an alignment rod extending between respective alignment bosses of said inner and outer clamping bars for aligning said clamping bars with respect to each other.

15. The clamping system of claim 11 wherein each said tether strap includes first and second snap fastener elements spaced apart along the length thereof such that a free end of each strap can be wrapped around said upper frame portion of the vehicle door frame and said first and second snap fasteners can be connected together to secure such tether strap in position.

16. The clamping system of claim 15 including clip means for adjusting the length of each such tether strap to compensate for different sizes of vehicle doors.

17. The clamping system of claim 11 including, for each suction cup, a hinged bracket affixed to an inner face of said second clamping unit inner clamping bar and to an adjacent surface of such suction cup.

18. The clamping system of claim 11 including, for each suction cup, a hinged bracket affixed to a lower face of said second clamping unit inner clamping bar and to an adjacent surface of such suction cup.

19. A method of training emergency measures personnel in gaining entrance to a vehicle normally having automotive glass in a door thereof, such door having a window opening, forward, upper, and rearward frame portions defining such window opening and a lower outer panel member below the window opening, comprising the steps of:
lowering the automotive glass normally closing such window opening in such vehicle door to expose and interior of such vehicle through the window opening;
positioning exterior to the window opening a second sheet of automotive glass held by the clamping system of claim 1 such that said second sheet of automotive glass covers substantially the entirety of said window opening;
securing said first and second clamping units of said clamping system to, respectively, the upper frame portion and the lower outer panel of said vehicle door by way of said first and second supporting means respectively;
conducting a training exercise, which exercise includes the breaking of said second sheet of automotive glass to gain entrance to the interior of such vehicle; and
following said exercise, replacing the broken sheet of automotive glass in said clamping system such that another training exercise can be conducted with a new sheet of automotive glass positioned exterior to the window opening.
